(19) United States
(12) Patent Application Publication
(10) Pub. No.: US 2007/0106724 A1
(43) Pub. Date: May 10, 2007

(54) Enhanced IP conferencing service

(76) Inventors: Sreenivasa Rao Gorti, Austin, TX (US); Hisao M. Chang, Austin, TX (US)

Correspondence Address: BRINKS HOFER GILSON & LIONE, P.O. BOX 10395, CHICAGO, IL, 60610, US

(21) Appl. No.: 11/267,239

(22) Filed: Nov. 4, 2005

(51) Int. Cl. G06F 15/16

(52) U.S. Cl. 709/204

(57) ABSTRACT

A system and method are disclosed for enhanced IP conferencing. In one embodiment, the enhanced IP conferencing allows for joining a conference call through a calendaring application. A web page or GUI is created that keeps track of all conference call participants, and monitors who is speaking along with speaking data, tracks the speakers and maintains a condensed transcript of the conference call.

### BACKGROUND

It is common for business to be conducted remotely through electronic communications. It is more efficient and cost effective to conduct meetings through conferencing technologies rather than undergo time-consuming and costly travel. Teleconferencing permits anyone to participate in meetings and conferences regardless of their geographic location.

Traditional audio conferencing approaches have a limited ability to combine with data applications. Web conferencing, in certain applications, is available, but may be inefficient and require an improved interface. As one example, users typically have to manually enter the Conference Bridge and password to join a conference.

Further, large conferences with many participants can be disorganized because of the number of participants. Time can be wasted by participants being required to announce their presence in the conference. Likewise, time is wasted when each speaker must identify themselves so that others know who is speaking. Most multimedia conferencing technologies today lack intelligence for automatically identifying active speakers at a given time. Attendees of the existing multi-media conferencing services would have to manually “grab” the microphone such as clicking a button on the conference's web page in order to notify the other attendees of his/her talking now.

Also, it can also be difficult to join a conference or meeting mid-stream and be up to speed on what has transpired. Transcribing of conferences is known. However, certain existing text caption techniques for multi-media conference services dump output text in the same format regardless of the form factor of a client device from which an attendee signs into the conference. This may require the attendee to scroll many screens in order to reach a desired page.

### BRIEF DESCRIPTION OF THE DRAWINGS

The components and the figures are not necessarily to scale, emphasis instead being placed upon illustrating the principles of various embodiments.

FIG. 1 is a flow diagram illustrating a method according to one embodiment;

FIG. 2 is a block diagram illustrating a system according to one embodiment;

FIG. 3 is a flow diagram illustrating a method according to one embodiment;

FIG. 4 is a flow diagram illustrating a method according to one embodiment;

FIG. 5 illustrates an embodiment of a display;

FIG. 6 illustrates a second embodiment of a display; and

FIG. 7 is a block diagram illustrating a system according to a second embodiment.

### DETAILED DESCRIPTION

By way of introduction, the embodiments described below include a method to enhance IP-based conferencing based on analyzing the IP signaling and media protocols coordinated with speech analysis techniques, to significantly improve end user experience for conference calls. In one embodiment, the conferencing technique described below is in the context of a network Voice Over IP (“VoIP”) context.

In a first aspect, a method is provided for IP conferencing. The method includes: connecting to a VoIP (“Voice over IP”) conference call over a network; initiating an application display; receiving identification information of the participants in the conference call over the network, wherein the application display is operable to display the identification information of the participants; and receiving tracking information over the network when the participants in the conference call are speaking and displaying the tracking information on the application display, wherein the tracking information comprises at least one of a transcript of the conference call, a portion of the transcript, keywords from the transcript, and a combination thereof.

In a second aspect, a conferencing system is provided including an IP-based network; a telecommunications device coupled to the IP-based network and operable to connect with a conference call; and a display coupled to the device, wherein the display is operative to identify participants in the conference call, monitors the participants who are speaking, and maintains a condensed speech transcription of the conference call.

In a third aspect, a computer readable storage medium includes instructions executable by a programmed processor for connecting to a conference call. The instructions include: connecting to a network; joining the conference call over the network; receiving speaking information from the network on participants of the conference call; and displaying a condensed transcription based on the participants that speak in the conference call.

In a fourth aspect, a method for internet protocol (“IP”) conferencing is disclosed. The method includes: hosting a conference call; determining identification information of participants in the conference call; providing identification information to the participants; tracking when the participants in the conference call are speaking; and recording and providing at least one of a transcript of the conference call, a portion of the transcript, keywords from the transcript, or a combination thereof; to the participants based on an input from the participants.

In a fifth aspect, a method for internet protocol (“IP”) conferencing is disclosed. The method includes: connecting to a conference call; initiating an application display; displaying identification information of participants in the conference call; and displaying a speaking meter operative to display the identification information of the participants in the conference call and displaying an indication of the speaking time of each of the participants.

Other systems, methods, features and advantages will be, or will become, apparent to one with skill in the art upon examination of the following figures and detailed description. It is intended that all such additional systems, methods, features and advantages be included within this description, be within the scope of this disclosure, and be protected by the following claims and be defined by the following claims. The present disclosure is defined by the following claims, and nothing in this section should be taken as a limitation on those claims. Further aspects and advantages are discussed below in conjunction with the embodiments.

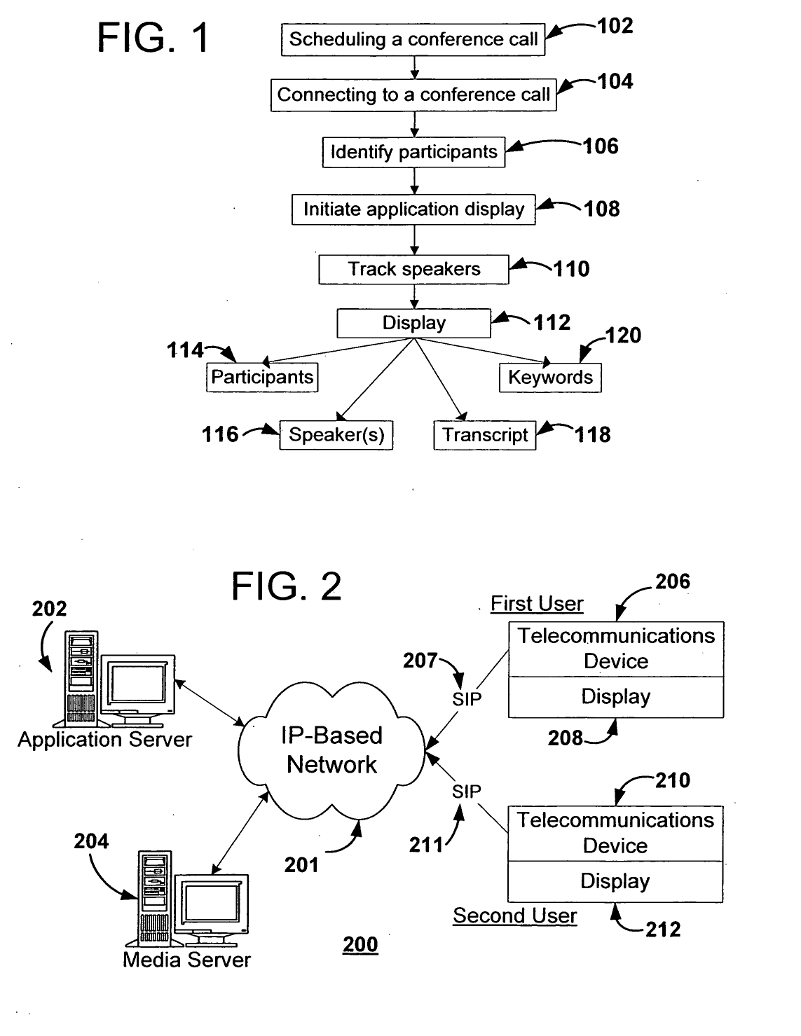

FIG. 1 is a flow diagram illustrating a method according to one embodiment. As an overview, a conference call is scheduled in block 102, users connect to the conference call in block 104, all participants are identified in block 106, and an application display is initiated for the participants in block 108. As the conference call is taking place, the speakers are tracked in block 110 and each user has a display in block 112 showing the participants in block 114, the speakers in block 116, a transcript in block 118, or keywords in block 120 from the conference.

First, a conference call or meeting is scheduled in block 102. Notification of the scheduling of the call can be transmitted electronically to all potential participants of the call. In one embodiment, the scheduling takes place in a calendaring application such as Microsoft Outlook. Alternatively, any graphical user interface (“GUI”) with scheduling abilities or a web page configured with the scheduling capabilities may be used for the scheduling or the joining of a conference as a calendaring application. In one embodiment, the calendaring application can receive electronic notice of a scheduled conference call. A plug-in to the calendaring application then automatically associates the conference bridge password information with the incoming conference call meeting notice. The conference call may be an audio conference, or alternatively, may be configured for a video conference. A user can open up the conference call notice or the calendaring application automatically presents the user with a “join” button. Clicking the “join” button connects the user to the conference call.

The user can manually connect, or a calendaring application can automatically connect to the conference call in block 104. Joining the call directly from a calendaring application requires no explicit log-in. When the conference server is in the same trust domain as the user's desktop application/device, the implicit log-in uses the corporate Single Sign On implementation. When the conference server is in a different domain, the join request is routed through a corporate proxy server that is able to assert the user's identity. This user's identity may be referred to as identification information. This may involve direct passing of the user's security credentials as a part of the request (encapsulated as HTTP/SOAP headers, for example), or involve a SAML (Security Assertions Markup Language) request/response. The log-in is thus directly federated to the conference service when invoking the conference call.

Referring now to FIG. 2, which is a block diagram illustrating a system 200 according to one embodiment. The system shows multiple users connecting to a conference call over a network 201.

A first user connects to a conference call with a telecommunications device 206. System 200 shows a first and second user. Likewise, the second telecommunications device 210 is connected to the conference call through the network 201. Any number of users, participants, or telecommunications devices can be connected to the conference call through network 201.

Both telecommunication devices 206, 210 are connected to an IP-based network 201. The telecommunications devices 206, 210, a media server 204, and an application server 202 are connected to the network 201. A telecommunications device 206 or 210 may be telephone, such as a cellular phone, a land-line phone, or any phone operable to connect to an IP-based network 201. Alternatively, the telecommunications device 206 or 210 may be a computer, or a personal digital assistant (“PDA”). The telecommunications device 206 or 210 connects to the network 201 and is operable to engage a used in conference call through either the receipt or transmission of data. That data may be audio, video, or text that is received by the telecommunications device 206 or 210.

The first user's telecommunications device 206 is coupled with display 208. Likewise, the second user with telecommunications device 210 also has a display 212. In one embodiment, each user or telecommunications device has a display 208 or 212, which includes information about the conference call, the participants, the speakers, and the topics or transcript of the conference call. The displays 208 or 212 depend on the type of telecommunications device 206 or 210. A computer has a standard LCD monitor or other visual display. Likewise, PDA's and cellular phones also come with built-in displays that are operative to display information from a conference call.

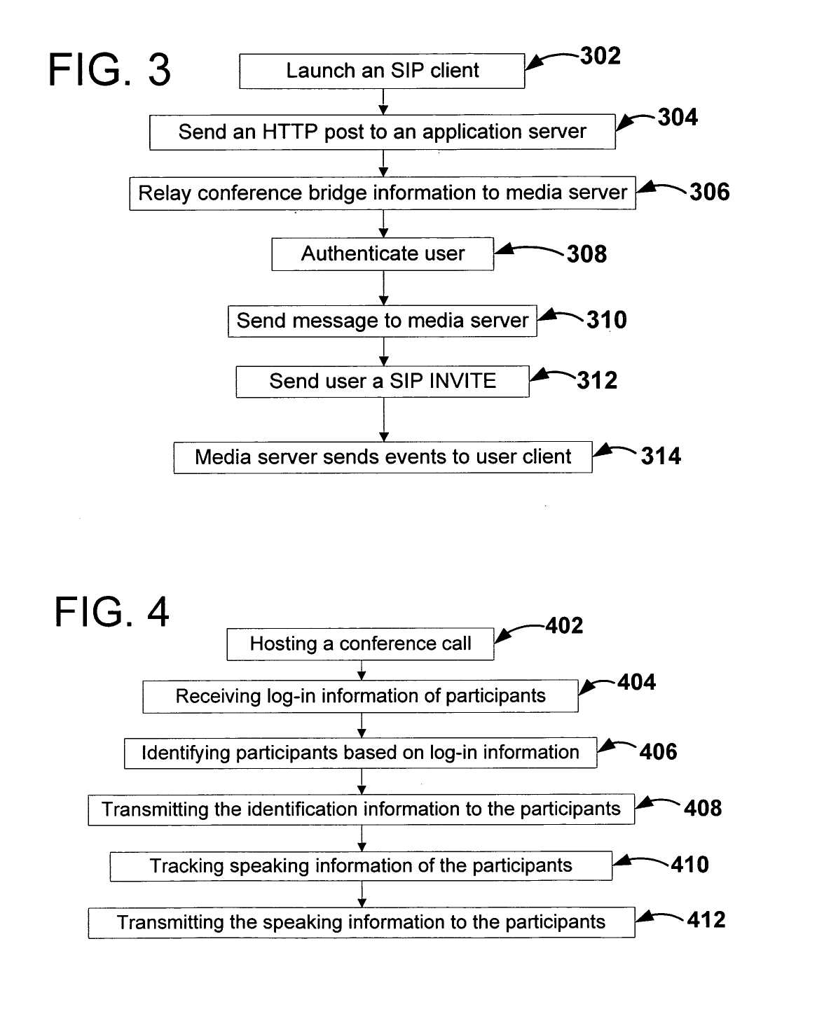

Referring now to FIG. 3, which is a flow diagram illustrating a method according to one embodiment. An enhanced Session Initiation Protocol (“SIP”) client is launched in block 302 when a user connects to the conference call with a telecommunications device 206, 210. In an alternative embodiment, rather than a SIP client, an enhanced calendaring client could also be launched in block 302. The SIP client 207, 211 sends a HyperText Transport Protocol (“HTTP”) post to an application server 202 in block 304 with the conference bridge information relayed to a conference-bridge media server 204 in block 306 as Extensible Markup Language (“XML”) data. This post also contains the SIP address of the user. The application server 202 authenticates the user in block 308, and sends a message to the media server in block 310 to add a conference participant. The application server 202 sends a SIP INVITE, and the media server 204 is patched through a standard SIP third-party call set up as in block 310. In an alternative embodiment, the media server 204 sends the user a SIP INVITE in block 310. Additional events from the media server carry the conference status as in block 314. The conference status information may include participants, speakers, or speaker changes. The body of the events may be carried as XML data. Alternate event mechanisms may be used instead of SIP INFO. The alternate event mechanisms could be a simple TCP event channel, XML/TCP event interface, Java RMI event channel or SIP INFO with XML data.

A user joins the conference call as discussed above, which provides a convenient mechanism for identifying all the participants 106 who join the conference. The log-in is directly federated to the conference service using Security Assertion Markup Language (“SAML”) assertions when invoking the conference call. SAML is a standard for transferring authentication and authorization data between domains.

Accordingly, an analysis of the Real-time Transport Protocol (“RTP”) origin streams can be used to identify participants. The RTP origin stream through which a user joins the conference call uniquely identifies participants. Implicit speaker recognition through an analysis of RTP stream origination supports multiple people speaking simultaneously. The RTP stream origination may also be referred to as identification information. RTP is a standard format for transferring data packets, typically either video or audio. RTP helps for consistent packet transfer over an IP network, and is frequently used in VoIP applications.

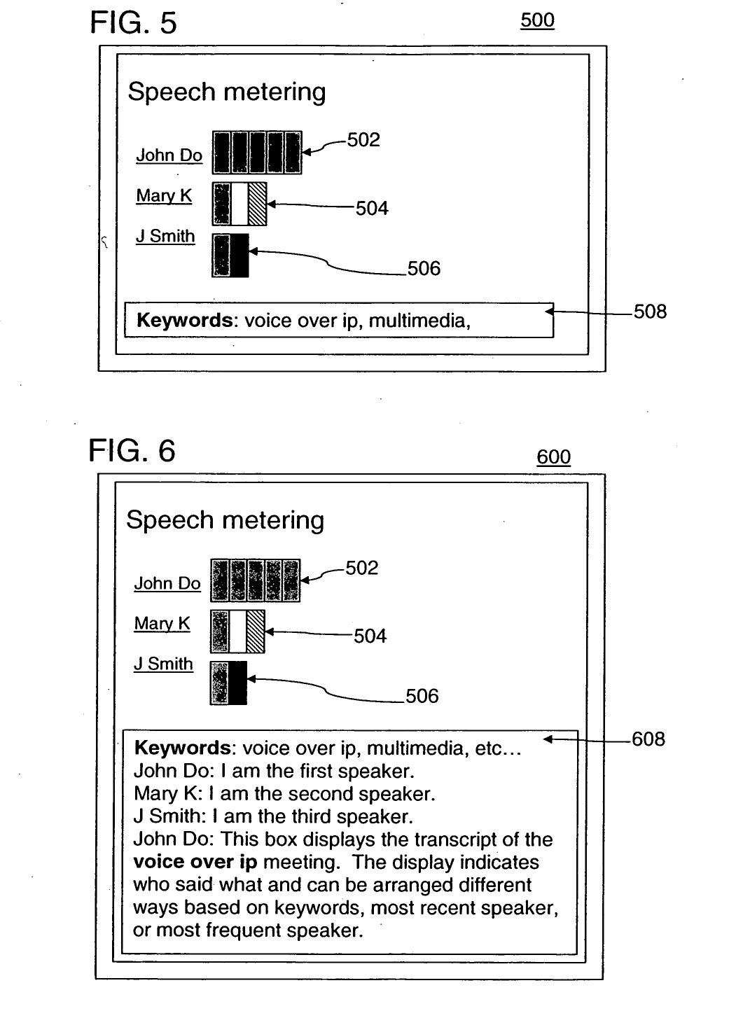

FIG. 4 is a flow diagram illustrating a method according to one embodiment. It is representative of the server end. The server may be either the application server 202 or the media server 204. The server hosts a conference call in block 402. Acting as a host, the server allows participants to joining the conference call over the network. The participants log-in to the conference call and the server receives the log-in information in block 404. Participants are identified based on the log-in information in block 406. The identification will be discussed below. The server can provide, transmit, or communicate the identification information to the participants in block 408. The server can also track the participants that speak in the conference call in block 410. The tracking information or speaking information may then be provided, transmitted, or communicated to the participants in block 412. The speaking information is displayed by the participants as in FIG. 5 and FIG. 6.

Referring now to FIG. 2, an IP-based network 201 can use IP addresses from the users as identification. Each participant is associated with a unique IP address, which therefore identifies which participants have joined the conference call, and further which participants are speaking or have spoken during the conference call.

Upon joining a conference call, users have an application display in block 108, such as in FIG. 5 and FIG. 6. On a computer, the application display could be either a web page or GUI. Likewise, for a mobile phone, the display can be implemented as either a web page or a GUI or other software display program. The application display contains features that make the conference call more efficient and organized for all participants. The described and illustrated application display is an exemplary embodiment.

Both FIG. 5 and FIG. 6 illustrate embodiments of the application display. Specifically, display 500 is a smaller display that would be appropriate for smaller telecommunications devices such as mobile phones or PDA's. Display 500 is suitable for a larger device such as computer with a larger display.

One of the features on the application display may be a speaking meter as in block 110, identifying who is speaking and who has spoken along with statistics on the amount and content of the discussion from each speaker. Speaking meters 502, 504, 506 are shown in FIG. 5 and FIG. 6.

For each participant, the media server creates a voice-activated “speaking meter” or display in block 112. The display in block 112 may display at least of subset of participants in block 114 in the conference call and may display at least a subset of speakers in block 116.

During the conference, when a participant speaks, his/her speech will activate their corresponding speaking meter. If more than one participant speaks simultaneously, their corresponding speaking meters will be activated at the same time. Activation can be done a number of ways. A current speaker's meter may blink, or may be a certain color such as green. Alternatively, the speaking meters may have different shading to indicate the amount or frequency they have spoken. In one embodiment, each bar of the speaking meters 502-506 represents a finite period of time or time interval, such as 10 minutes, and the shading represents the amount a participant has spoken. A light color bar could indicate little or no speaking, whereas a dark colored bar indicates a lot of speaking during that period. In this example, the John Do 502 spoke consistently throughout the conference call, however, J Smith 506 spoke the most in the most recent time period. Mary K 504 may have her meter blinking which shows she is the current speaker. Colors of the bars could be used to represent other details such as when a user joined the conference call, the frequency of speech, who is the conference host or in charge of the conference call, or the colors could represent the subject, which a participant has spoken about. Alternatively, the time interval of the meeting may be represented by another identifier other than a bar.

When a telecommunication device 206 or 210 joins the conference, the System 200 establishes a unique voice path to a listener, a software module, running on the SIP-based media server 204. Because this listener is dedicated to each voice path for each device 206 or 201, it only monitors the voice activity on that voice path and therefore knows precisely when the user starts speaking and when to stop. As soon as the listener is detecting the beginning of a speech utterance spoken by the user, it requests an automatic speech recognition (ASR) port served by the ASR server residing on the application server 202. The listener then forwards the speech utterance in real time through a stream-audio path to the ASR port, an instance of the ASR server running on the application server 202. The ASR port recognizes the utterances spoken on a word-by-word basis, generating a text-based transcription for the System 200 to use.

When the System 200 receives one or more text-based transcriptions from each ASR port, it passes the full-text transcription to a Text Compression software module residing on the application server 202. This Text Compression software compresses a full-text transcription from a speech segment belonging to a given end-user into multiple versions, each with a different compression ratio. For example, a full-text transcription may be 120 words per minute (typical speaking rate for an American English speaking adult). At a next level, the transcription may be reduced to 60 words per minute, and etc. The Text Compression software keeps a key word library based on the word relevance in context of the meeting agenda. Therefore, at each level of text compression, the Text Compression software always keeps those words in the full-text transcription that are most relevant to the meeting agenda or most frequently spoken by most of the speakers.

The System 200 keeps this multi-tier transcription body all the times during the conference. Whenever a telecommunication device 206 or 210 joins the conference, the System 200 knows the device display characteristics based on the device profile during the registration and authentication process. Therefore, for a device with a smaller display 500, the System 200 will request a more condensed version of the transcription for a given speaker and then send the data to the end-user device 206 or 210. For a device with a larger display 600, the System 200 will request a version of the full-text transcription with a number of transcribed words per minute that is most appropriate to an end-user device 206 or 210.

In an alternate embodiment, the application display includes a multi-face speaking meter next to each participant's name. This multi-face meter may have two parts: one containing a numerical number representing hours and minutes like “1H:25M”, and the second part showing a multi-shade bar meter, similar to what was discussed above. The numerical number may represent the amount of time a participant has been present in a conference call or the amount o time that participant has spoken. The chart may be lit with a brightness level reflecting who has spoken during the last N minutes. For example, if a participant has spoken 10 minutes at the early part of the conference, but over the next 50 minutes does not say anything, his/her bar meter may be dimmed or completely grayed-out.

The application server 202 sorts the readings of the speaking meters based on a set of rules configurable by the conference host. For example, the meter readings can be ranked by the overall speaking time for all the attendees during the meeting. Also, the meter readings can be ranked by a recency factor, that is, based on the last N attendees who spoke during the last M minutes. The organization of the speaking meters can be displayed and arranged in a number of ways to convey the relevant information.

The application server 202 can periodically refresh the conference participant page so that the names will be presented in a certain sequence. For example, the participant who spoke the longest time during the conference up to that point will be displayed on the top of the page. This will be particular useful when a participant signed into the conference participant page from a small-screen device. Thus, even for a large conference with 50 or more attendees, any attendee from any client device can see who is speaking at the current time (displayed on the very top) or who has done most of speaking during the conference (the primary speakers). The media server 204 sends the readings of all speaking meters to the application server according to a configurable refresh rate.

Exemplary application displays are shown in FIG. 5 and FIG. 6. The display 500 is shown with an abbreviated transcript box 508, which is ideal for a small-screen device such as a mobile phone or PDA. The display 600 has a more complete transcript box 608, which can display at least a subset of the transcript from the conference call.

The display 600 shows a transcript box 608, which may display the complete history in terms of speech by the participation from the beginning to the end of the meeting. The list may be presented in different views, for example, by who has spoken the most or by who has spoken most recently.

Speech activity can be tracked using both automatic speech recognition (ASR) and content relevancy ranking. Any speech activity may be referred to as speaking information or tracking information. The near real-time or real-time text caption for recognized speech allows all conference participants to track the up-to-the-minute history of a conference call. This feature allows late attendees to catch-up to the discussion in a non-intrusive manner.

The application server 202 maintains multiple templates of “text caption density” or “condensed speech transcription” for the conference attendee page depending upon a sign-on profile associated with each telecommunications device with which a participant signs into the conference call. For example, if a participant joins the conference from a common desktop environment in a personal computer, the entire text caption from the speech recognition of the spoken utterance by each speaker may be displayed next to that speaker's meter. Alternatively, the transcript of the conference call may be organized based on topics of conversation. Transcript box 608 may show the entire transcript of the conference call.

If a participant joins the conference with a small-screen device, the text caption density or condensed speech transcription for the recognized speech can be filtered so that only certain key phrases in the recognized speech are displayed like “. . . voice over IP, multimedia, etc. . . . ” The display 500 displays a transcript box 408 showing only the keywords from the conference. This is especially useful for the participants signing on with a small-screen device to keep up with the overall context of the discussion, or if he/she signs on during the middle of an ongoing conference.

The key phrases are determined by searching each word or phrase recognized against the subject line or conference agenda published by the conference host. The most relevant words or phrases of the text caption from recognized speech by a given speaker will be retained for the display to be seen by the other participants.

The “text caption density” or “condensed speech transcription” with key phrases is ideal for organizing information and for displaying a limited amount of information regarding a conference call. The automatic keyword generation (from lengthy text caption of recognized speech) proposed by this system, makes it possible to optimize the keyword ratio display based on screen size of a client device. For example, for a small hand-held device with 8-line screen, the caption set may be compressed to display only 10 words per minute of speech recognized. For a PDA or palm-top with 25-line display screen, the word ratio may be increased to 30 words per minute. Alternatively, for a 17″ wide-screen laptop computer, the entire transcription of speech recognized may be displayed for all or a subset of speakers. The user may enter input or request certain information, such as a keyword to be displayed or portions of the transcript.

An implementation of one embodiment is through software creating an application display such as a GUI or conference web page. The software can be stored on computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, filmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system.

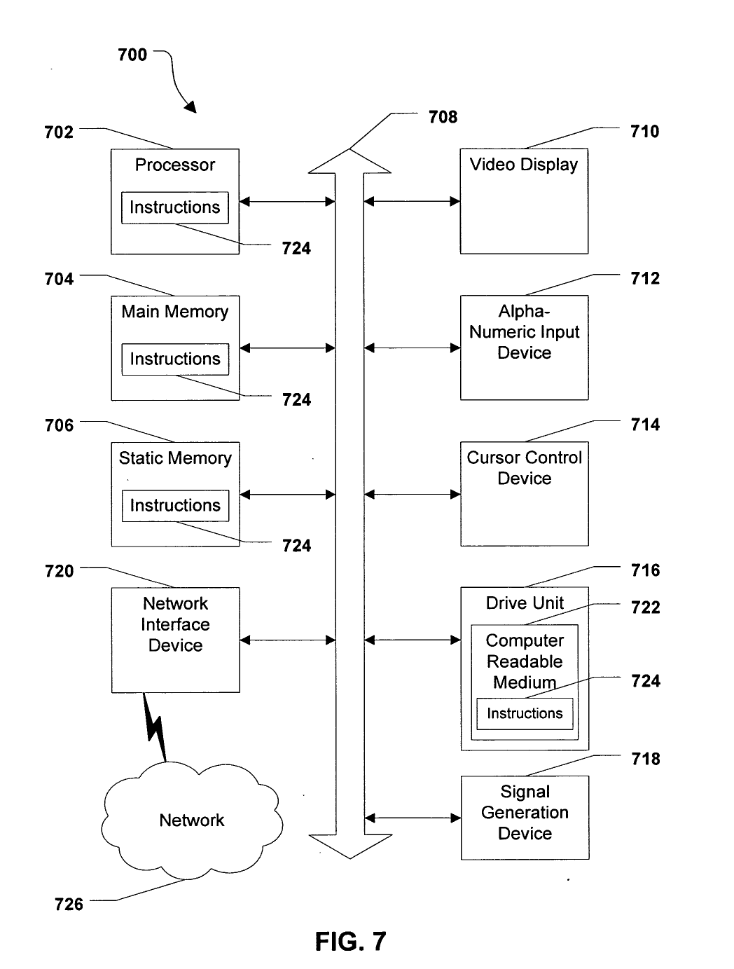

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the specification is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

It is increasingly common for business to be transacted remotely. Accordingly, meetings can be held through conference calls. The efficiency of the business and the meeting is dependent on the conferencing technology. An efficient mechanism to engage in a conference call is disclosed. The participants engaged in the conference call have access to a variety of relevant information regarding the other participants, speakers, amount and substance from each speaker's comments and transcripts or keywords of the conference.

1. A method for internet protocol (“IP”) conferencing comprising:
connecting to a VoIP (“Voice over IP”) conference call over a network;
initiating an application display;
receiving identification information of the participants in the conference call over the network, wherein the application display is operable to display the identification information of the participants; and
receiving tracking information over the network when the participants in the conference call are speaking and displaying the tracking information on the application display, wherein the tracking information comprises at least one of a transcript of the conference call, a portion of the transcript, keywords from the transcript, and a combination thereof.

2. The method of claim 1 wherein the step of connecting to a conference call further comprises the use of a calendaring application.

3. The method of claim 2 wherein the calendaring application automatically connects to the conference call.

4. The method of claim 2 wherein the calendaring application is Microsoft Outlook.

5. The method of claim 1 wherein the step of receiving identification information of the participants comprises an analysis of the log-in process for the participants.

6. The method of claim 5 wherein the log-in process comprises at least one of a SIP registration, a log-in to the application server, a log-in through Security Assertions Markup Language (“SAML”), and a combination thereof.

7. The method of claim 1 wherein the tracking information when the participants are speaking comprises an analysis of a Real-time Transport Protocol (“RTP”) origin stream of each of the participants.

8. The method of claim 1 wherein the application display comprises at least one of a web page, a Graphical User Interface (“GUI”), and a combination thereof.

9. The method of claim 1 wherein the application display is further operable to display at least one of an indication of a current speaker, a ranking of the participants based on speaking time, a listing of participants who spoke most recently, and combinations thereof.

10. The method of claim 1 wherein the application display further comprises a speaking meter indicating at least one of the participants who is currently speaking.

11. The method of claim 1 wherein the keywords from the transcript are automatically generated based on the key phrases spoken by the participants that are considered the most relevant.

12. The method of claim 11 wherein the key phrases that are considered the most relevant are those in a subject line or conference agenda.

13. A conferencing system comprising:
an IP-based network;
a telecommunications device coupled to the IP-based network and operable to connect with a conference call; and
a display coupled to the device, wherein the display is operative to identify participants in the conference call, monitors the participants who are speaking, and maintains a condensed speech transcription of the conference call.

14. The system of claim 13 wherein the telecommunications device is one of a mobile telephone, other telephone, computer, personal digital assistant (“PDA”), or any other device operable to connect to an IP-based network.

15. The system of claim 13 wherein the participants are identified based on an analysis of the log-in of the participants.

16. The system of claim 13 wherein the participants who are speaking are identified based on an analysis of Real-time Transport Protocol (“RTP”) origin stream.

17. The system of claim 13 wherein the display is further operable to display at least one of an indication of a current speaker, a ranking of the participants based on speaking time, a listing of participants who spoke most recently, and combinations thereof.

18. The system of claim 13 wherein the condensed speech transcription comprises at least one of a transcript for each of the participants, a portion of the transcript, keywords from the transcript, and a combination thereof.

19. The system of claim 18 wherein the keywords from the transcript are automatically generated based on the key phrases spoken by the participants that are considered the most relevant.

20. The system of claim 19 wherein the key phrases are determined by a participant of the conference call.

21. In a computer readable storage medium having stored therein data representing instructions executable by a programmed processor for connecting to a conference call, the storage medium comprising instructions for:
connecting to a network;
joining the conference call over the network;
receiving speaking information from the network on participants of the conference call; and
displaying a condensed transcription based on the participants that speak in the conference call.

22. The instructions of claim 21 wherein the speaking information comprises at least one of an identity of each of the participants, an indication of a current speaker, a ranking of the participants based on speaking time, a listing of participants who spoke most recently, and combinations thereof.

23. The instructions of claim 22 wherein the tracking a speaker is based on an analysis of the Real-time Transport Protocol (“RTP”) origin stream of that participant.

24. The instructions of claim 21 wherein the condensed transcription is at least one of a transcript for each of the participants, keywords from the transcript, and a combination thereof.

25. The instructions of claim 24 wherein the keywords from the transcript are automatically generated based on the key phrases spoken by the participants that are considered the most relevant.

26. A method for internet protocol (“IP”) conferencing comprising:
hosting a conference call;
determining identification information of participants in the conference call;
providing identification information to the participants;
tracking when the participants in the conference call are speaking; and
recording and providing at least one of a transcript of the conference call, a portion of the transcript, keywords from the transcript, or a combination thereof; to the participants based on an input from the participants.

27. The method of claim 26 wherein the step of identifying the participants of the conference call comprises analyzing the log-in process for the participants.

28. The method of claim 27 wherein the log-in process comprises at least one of a SIP registration, a log-in to the application server, a log-in through Security Assertions Markup Language (“SAML”), and a combination thereof.

29. The method of claim 26 wherein the step of tracking when the participants are speaking comprises analyzing a Real-time Transport Protocol (“RTP”) origin stream of each of the participants.

30. The method of claim 26 wherein the participants have an application display operative to display the identification information and the at least one of a transcript of the conference call, a portion of the transcript, keywords from the transcript, and a combination thereof.

31. The method of claim 26 wherein the input from the participants is a keyword.

32. A method for internet protocol (“IP”) conferencing comprising:
connecting to a conference call;
initiating an application display;
displaying identification information of participants in the conference call; and
displaying a speaking meter operative to display the identification information of the participants in the conference call and displaying an indication of the speaking time of each of the participants.

33. The method of claim 32 wherein the conference call is Voice over IP (“VoIP”).

34. The method of claim 32 wherein the speaking meter is operative to display at least one of a transcript of the conference call, a portion of the transcript, keywords from the transcript, and a combination thereof.

35. The method of claim 32 wherein the indication comprises a partitioned indicator representing an interval of time.

36. The method of claim 35 wherein an amount each of the participants speaks is represented by at least one of color, shading, or a combination thereof on the partitioned indicator.

37. The method of claim 32 wherein the speaking meter comprises bars representing the time intervals of the conference call.

38. The method of claim 32 further comprising displaying a plurality of speaking meters, wherein the plurality of speaking meters are each associated with a speaker and operative to display the identification information of the participants in the conference call and displaying an indication of the speaking time of each of the participants.
